(19) United States
(12) Patent Application Publication
(10) Pub. No.: US 2013/0127934 A1
(43) Pub. Date: May 23, 2013

(54) MULTIPLE RATE PROJECTOR

(71) Applicant: BASCULE DEVELOPMENT AG LLC, Wilmington, DE (US)

(72) Inventor: Kuo-Ching Chiang, New Taipei City (TW)

(73) Assignee: BASCULE DEVELOPMENT AG LLC, Wilmington, DE (US)

(21) Appl. No.: 13/719,169

(22) Filed: Dec. 18, 2012

Related U.S. Application Data
(63) Continuation of application No. 13/214,496, filed on Aug. 22, 2011.
Application No. 13/214,496 is a continuation-in-part of application No. 13/152,621, filed on Jun. 3, 2011.
Application No. 13/152,621 is a continuation-in-part of application No. 12/711,366, filed on Feb. 24, 2010, now abandoned.
Application No. 12/711,366 is a continuation-in-part of application No. 11/783,551, filed on Apr. 10, 2007, now Pat. No. 7,874,486.
Application No. 11/783,551 is a continuation-in-part of application No. 11/701,158, filed on Jan. 31, 2007.
Application No. 11/701,158 is a continuation of application No. 10/989,622, filed on Nov. 15, 2004, now Pat. No. 7,178,735.

(51) Int. Cl. G09G 5/10; G03B 21/20

(52) U.S. Cl. CPC G09G 5/10; G03B 21/2013
USPC 345/691; 353/31; 353/33

(57) ABSTRACT

A multiple rate projector comprises at least three different color light sources each configured to emit a different color of light, respectively. A color control module is coupled to the at least three different color light sources, and is configured to switch the at least three different color light sources on, respectively, to allow turn-on times of two of the at least three different color light sources to be overlapped or not overlapped. Overlapped turn-on times can be overlapped by a half cycle, or longer or shorter than a half cycle, of the on cycle of each of the respective different color light sources. A two-dimension reflector reflects light from the different color light sources to a projection location (e.g., on a projection screen).

### CROSS-REFERENCE TO RELATED APPLICATIONS

This application is a continuation of U.S. patent application Ser. No. 13/214,496, filed Aug. 22, 2011, the disclosure of which is incorporated herein by reference. This application is also a continuation-in-part of U.S. patent application Ser. No. 13/152,621, filed Jun. 3, 2011, which is a continuation-in-part of U.S. patent application Ser. No. 12/711,366, filed Feb. 24, 2010 (now abandoned), which is a continuation-in-part of U.S. patent application Ser. No. 11/783,551, filed Apr. 10, 2007 (now U.S. Pat. No. 7,874,486), which is a continuation-in-part of U.S. patent application Ser. No. 11/701,158, filed Jan. 31, 2007, which is a continuation of U.S. patent application Ser. No. 10/989,622, filed Nov. 15, 2004 (now U.S. Pat. No. 7,178,735), the disclosures of which are incorporated herein by reference.

### BACKGROUND

Cellular communications systems typically include multiple base stations for communicating with mobile stations in various geographical transmission areas. Each base station provides an interface between the mobile station and a telecommunications network. Mobile telephone systems are in use or being developed in which the geographic coverage area of the system is divided into smaller separate cells, which communicate with the network via a fixed station located in the cell. Mobile telephones belonging to the system are free to travel from one cell to another. When a subscriber within the same system or within an external system wishes to call a mobile subscriber within this system, the network must have information on the actual location of the mobile telephone.

Recently, the price of cellular telephones has been greatly reduced and become affordable to more people. It is common that a person owns more than one cellular phone. Some people even replace their cellular telephones as often as they replace their clothes or hairstyle. The cellular manufacturers have to release new models with different appearances, functions, and styles more frequently so as to attract the attention of the buyer and occupy a favorable market share. Furthermore, the conventional projector employs a white light lamp as a light source; therefore, at least two reflector lenses and at least three light-split lenses are required to split the white light into three colors (red, green, and blue). The optical lens set is expensive. The mechanism of the optical system is complicated and the size is difficult to reduce. Further, the lamp source will generate heat of high temperature.

### SUMMARY

The present disclosure describes a projector with a light switching rate that is a multiple of an image signal frame rate.

The portable device comprises a control IC and a projection display module for data projection. The portable communication device with embedded projector includes an RF module embedded in the portable communication device for wireless vocal communication; a built-in display embedded in the portable communication device for display; wherein the portable communication device comprises: a control IC; red, green, and blue light sources coupled to the control IC to illuminate a predetermined light, respectively; a light-guiding device coupled to the red, green, and blue light sources, wherein the red, green, and blue light sources, respectively, are positioned corresponding to the light-guiding device which is introduced to guide the light from the red, green, and blue light sources to the reflector; and a two-dimension reflector coupled to the light-guiding device to reflect a predetermined color light on a predetermined location defined by the control IC to enlarge the projection image.

In another aspect, the multiple rate projector comprises at least three different color light sources to illuminate a predetermined light, respectively; a color control module coupled to the at least three different color light sources to switch the at least three different color light sources; wherein a switching rate of the at least three different color light sources is a multiple of an image signal frame rate; and a two-dimension reflector reflects light from the at least three different color light sources to a location.

In another aspect, a multiple rate projector comprises at least three different color light sources to illuminate a predetermined light, respectively; a color control module coupled to the at least three different color light sources to allow the at least three different color light sources to be switched on, respectively, to allow turn-on times of two of the at least three different color light sources that are not overlapped, or the turn-on times of two of the at least three different color light sources are overlapped with half cycle, or longer or shorter than half of one cycle of each of the at least three different color light sources; and a two-dimension reflector reflects light from the at least three different color light sources to a location. A light-guiding device is provided to allow the at least three different color light sources located on three sides of the light-guiding device. The light-guiding device includes an X cube, X plate, or prism.

A further aspect of the present disclosure is a portable device comprising a control IC embedded in the portable device; an RF module coupled to the control IC for wireless communication; a display, a memory, and an input unit coupled to the control IC; and a remote control module coupled to said central control IC to control or lock a device by the key code coded in the memory.

Embodiments of the present disclosure can be integrated into a portable device. A portable device comprises a control IC embedded in the portable device; an RF module coupled to the control IC for wireless communication; a display, a memory, and an input unit coupled to the control IC; and a light source embedded in the portable device for acting as a pointer or flashlight. The light source can include a laser component. The light source also can include a lamp (or LED) and a reflector positioned in accordance with the lamp to reflect light generated by the lamp.

### BRIEF DESCRIPTION OF THE DRAWINGS

The foregoing aspects and many of the attendant advantages will become more readily appreciated as the same become better understood by reference to the following detailed description, when taken in conjunction with the accompanying drawings, wherein:

FIG. 1 shows a diagram of a cellular terminal according to the present disclosure.

FIG. 2 and FIG. 3 show diagrams of a projection display module according to the present disclosure.

FIGS. 4 to 6B show diagrams of a projection display module according to the present disclosure.

FIGS. 7A to 7D show timing diagrams of image signal frame and light sources according to the present disclosure.

FIGS. 7 and 8 show diagrams of a media player and digital camera with the projection display module according to the present disclosure.

FIG. 9 shows a diagram of a notebook computer with the projection display module according to the present disclosure.

### DETAILED DESCRIPTION

The present disclosure relates generally to a multiple rate projector and multi-function portable terminal. The term portable terminal includes, but is not limited to, a cellular phone, PDA (personal digital assistant), notebook computer, tablet, smart phone, digital camera, media player, and the like.

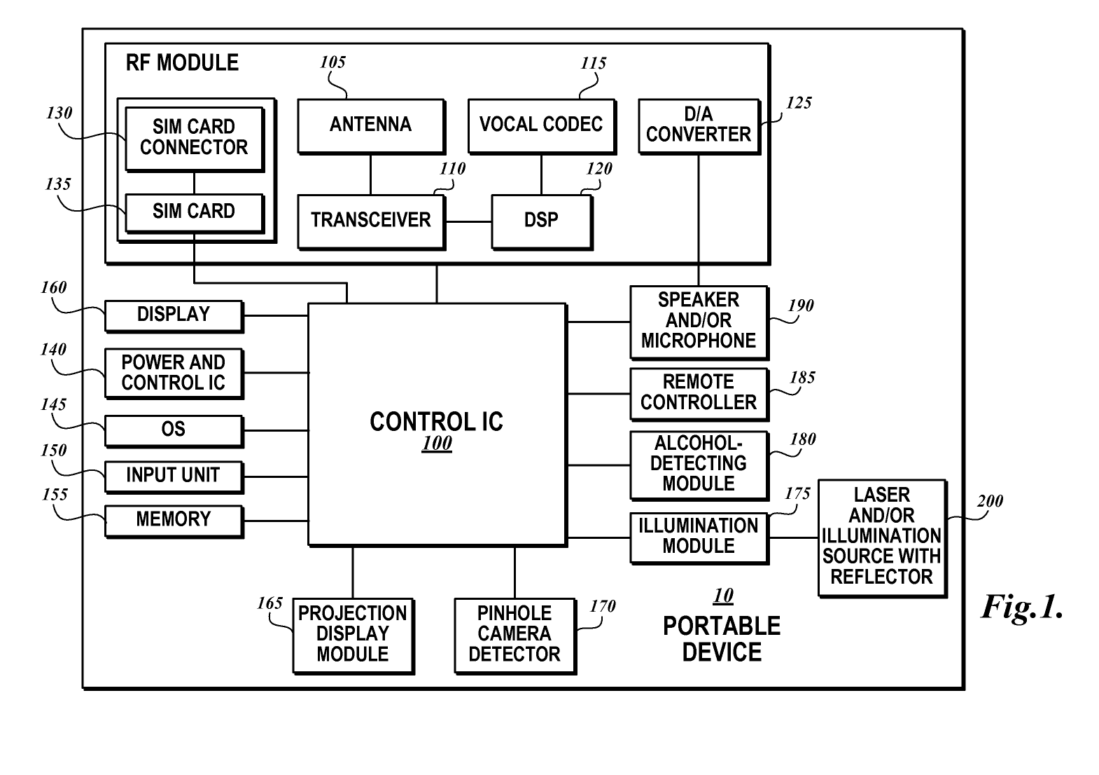

FIG. 1 shows a block diagram of a portable terminal with a SIM card connector 130 to carry the SIM card 135. As is well known in the art, the SIM card is not necessary for some types of cellular phones, such as in a PHS system. The diagram is used for illustration and not used for limiting the scope of the present disclosure. The portable terminal or device 10 includes an RF module. As known in the art, the RF module includes an antenna 105. This antenna 105 is connected to a transceiver 110, which is used to receive and transmit signals. The RF module further includes CODEC 115, DSP 120, and D/A converter 125 as well. The device 10 includes a central control IC 100, an input unit 150, a built-in display 160, OS 145, power and control IC 140, and memory 155 including a ROM program memory, a RAM memory, and a nonvolatile FLASH memory. The RF module may perform the functions of signal transmitting and receiving, frequency synthesizing, base-band processing, and digital signal processing. The SIM card hardware interface is used for receiving a SIM card. Finally, the signal is sent to the final actuators, i.e., a loudspeaker and a microphone 190.

Functions and modules described herein can be implemented alone or in combination with each other or with other functions and modules, as may be desirable for a given implementation.

In described embodiments, pinhole camera detector 170 indicates the addition of a device, which is suitable for wireless or wired signals. The pinhole camera detector is sensitive to the transmittance frequency, for example, from 300 MHz to 2.5 GHz, and is coupled to the control IC 100. The detector also includes a switch coupled to a pinhole camera detector to activate the detector. The pinhole video camera includes a printed circuit board, a charged coupled device (hereinafter referred to as “CCD”), memory means for storing a single frame image which is generated by an image signal from the CCD and a signal converting means, a connector with wires to connect the aforementioned circuits to a power source and the displayer. A conical convex lens is accommodated to have an apical angle and the apex is fixed so as to face the pinhole. The pinhole camera detector 170 is available to scan and detect the operation frequency while the pinhole camera is functioning. A so-called spy camera could also be detected by the pinhole camera detector 170 as well. The scanned result can be sent to the display 160 and/or the loudspeaker and a microphone 190, thereby sending an alarm signal.

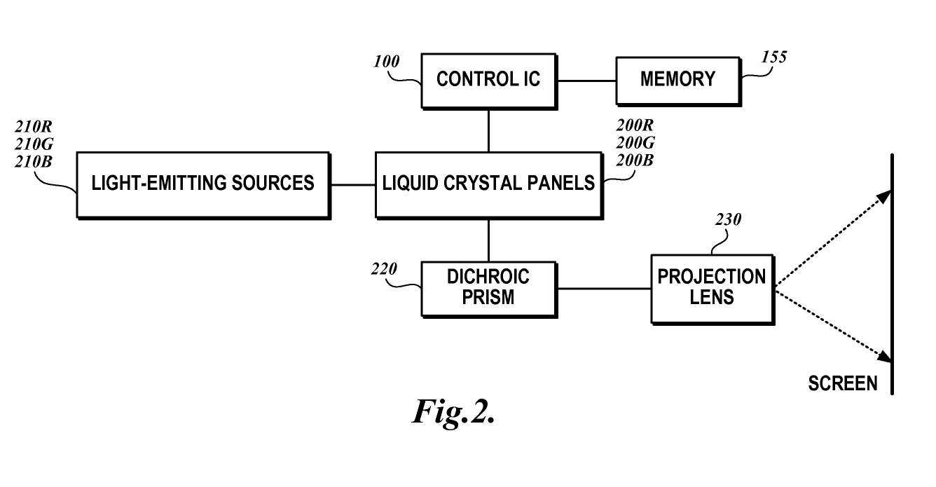

Moreover, the portable terminal shown in FIG. 1 has another function module described with reference to FIG. 2. A projection display module 165 is coupled to the control IC 100. One type of such a projection display module 165 that is known is the liquid crystal projector, whereby images on a liquid crystal panel are enlarged and projected by a projection lens onto a reflective screen and thus displayed. The liquid crystal projection display module comprises a light source lamp unit inside a shell of the device. Electrical discharge lamps such as metal halide lamps or halogen lamps could be used in the light source lamp unit. The light emitted from this light source lamp unit is guided via a mirror to dichroic mirrors, whereby it is separated into red light, green light, and blue light. The images displayed on the three liquid crystal panels, respectively, are illuminated by their respective colors, and this light is combined by a dichroic prism.

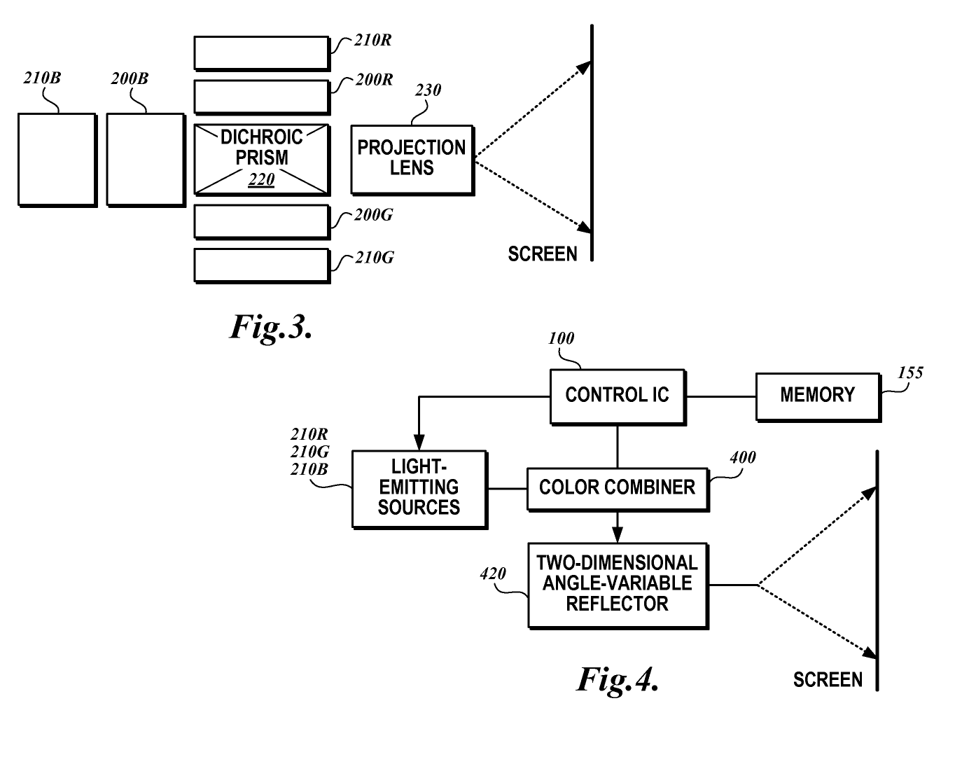

In an embodiment, described with reference to FIG. 3, the liquid crystal projector comprises three liquid crystal panels 200R, 200G, and 200B that perform image displays in red, green, and blue, respectively. Preferably, panel-form light-emitting sources 210R, 210G, and 210B are employed and positioned in correspondence with the liquid crystal panels, respectively. In one embodiment, the light-emitting sources 210R, 210G, and 210B are organic EL (electroluminescence) elements. These organic EL elements are electric-field light-emitting thin films that are capable of emission of red, green, and blue light. The EL elements are formed behind and adjacent to the liquid crystal panels 200R, 200G, and 200B, respectively. The liquid crystal panels 200R, 200G, and 200B and the light sources 210R, 210G, and 210B are positioned on the light-incidence side of the side surfaces of the dichroic prism 220 for each display color combination. The projection lens 230 could be made up of a plurality of lenses. Thus, the data or file stored in the memory of the device can be projected on a screen or wall. It allows the user to project the image, game, or file on an external screen. The EL element is small, flat form, and lightweight; therefore, it allows a small projector to be integrated in the portable device.

A further aspect of the present disclosure is that the device 10 also includes remote control module 185. The remote control module 185 may be used to control or lock the device by the key code coded in the remote control module 185. The remote controller is also a mature technology. Remote controllers for electrical and electronic appliances are well known, and are widely used. In one example, the remote control module 185 applies infrared rays for transmission, and each company provides its appliances and remote controllers with its specific protocol of communication. An example of the remote control module 185 is provided with an interface for downloading the relevant information into the remote control module 185 from an external source. In one embodiment, the remote controller is provided with an infrared transmitter for sending remote controlling signals to the appliance. The remote controller is provided with a RAM, ROM, EPROM, or EEPROM (memory 155) to which set-up information regarding the key-map and signal format of at least one apparatus to be controlled is entered (e.g., into an internal database). Such information can be commonly provided to the internal database from various sources, such as from a smart card, from an Internet database, from a plugged-in card, etc. The database in the appliance contains set-up data that can be transmitted by the transmitter to the remote control module 185, providing it all the information it needs in order to control the appliance. In one embodiment, the device uses the RF module to download the key code from a database through a network.

Another aspect of the present disclosure is that an embodiment of the portable device 10 also includes an alcohol-detecting module 180. The alcohol ingredients detecting module 180 is provided and coupled to the control IC 100 to detect the alcohol ingredients from one's breath, for example, the module is capable of detecting alcohol content in a breath sample. The alcohol-detecting module 180 is sensitive to the aforementioned alcohol content. If the bonding is detected, the signal can be sent from the alcohol-detecting module 180 to the control IC 100 for determining the level of alcohol ingredients. Then, the result can be sent to the display 160. U.S. Pat. No. 5,907,407 disclosed various methods for detecting alcohol. U.S. Pat. No. 4,809,810 disclosed a system, both apparatus and method, for analyzing a breath sample.

Further, an illumination module 175 is also described in the present disclosure. The portable device could be used as a laser pointer if the illumination module 175 includes a laser component 200. A switch can be provided to activate the laser. In another embodiment, the illumination module 175 includes a light source to allow the portable device to be used as a flashlight. For example, one may turn on the illumination module 175 in a dark environment, such as in a theater. The illumination module 175 could be coupled to the control IC 100 or implemented with an independent control IC. In some embodiments, the illumination module includes a laser component. In some embodiments, the illumination module includes a lamp (or LED) and a reflector positioned in accordance with the lamp to reflect light generated by the lamp. The aforementioned laser devices or LED could be user used for the projector as the aforementioned panel-form light sources as well.

An embodiment is now described with reference to FIG. 4. Light-emitting sources 210R, 210G, 210B (which also can be referred to as light sources, illumination sources, etc.) are coupled to the control IC 100. The control IC sends an image control signal to the light sources 210R, 210G, 210B, respectively. The light sources 210R, 210G, 210B are all independent light sources, such as LED, OLED, or laser. The images are enlarged and projected by a two-dimension reflector onto a reflective screen, and thus displayed. A color combiner (or illuminator combiner) 400 will receive the light from each of the light sources 210R, 210G, 210B, thereby constructing a demanded color which is determined by the control IC 100. The color combiner (or illuminator combiner) 400 can mix any color via the R, G, B light sources at any timing controlled by the control IC 100. A two-dimension angle-variable reflector 420 is coupled to the color combiner (or illuminator combiner) 400 to reflect the combined light to a predetermined location on the screen. The two-dimension angle-variable reflector 420 may change the angle between the normal line of the screen and the reflected beam. Preferably, the two-dimension reflector 420 comprises a thin membrane which can reflect light along the X- and Y-axis to show the image pixel-by pixel. It can be made by digital minor technology or micro-electromechanical systems. The light sources can include a laser, LED, or OLED to emit a laser beam to the two-dimension reflector for horizontally moving the laser beam at a first sweep frequency along an X-axis, and vertically moving the laser beam up or down along the Y-axis. The control IC is operative for controlling a two-dimension reflector to ensure that the pixel of the image can be reflected to a demanded location. A driver of the two-dimension reflector drives the angle of the two-dimension reflector. The driver horizontally sweeps in the X-direction to form a horizontal scan line from one point, then the driver adjusts the angle to move the scan line to the next vertical position, followed by sweeping again in the X-direction to form a second horizontal scan line along the X-direction. The formation of successive scan lines proceeds in the same manner. The whole image can be scanned by one two-dimension reflector and can be made by digital minor technology or micro-electromechanical systems. The projection image can be displayed by the two-dimension reflector.

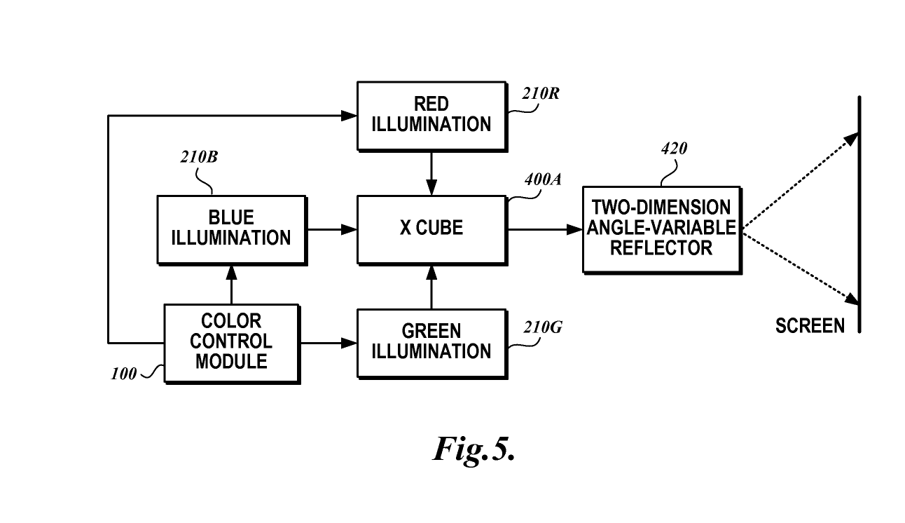

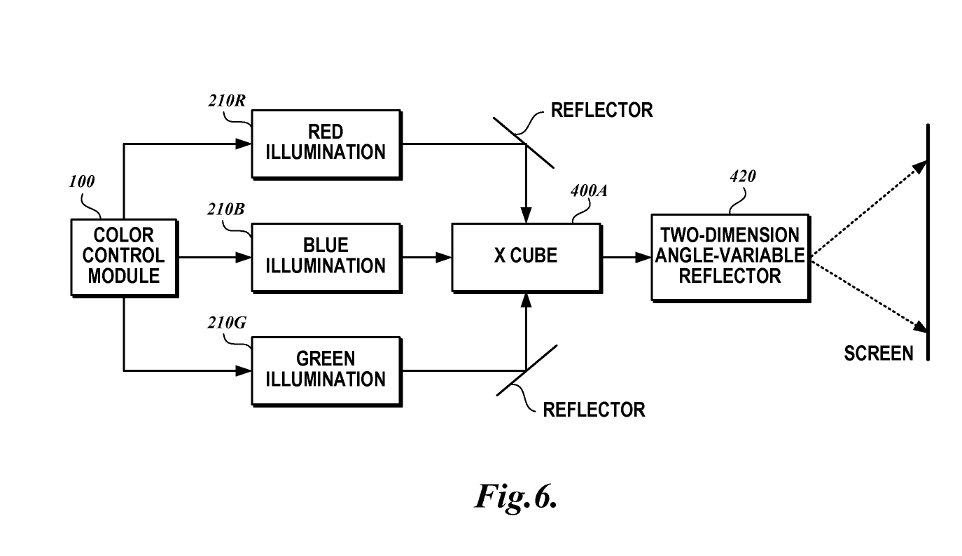

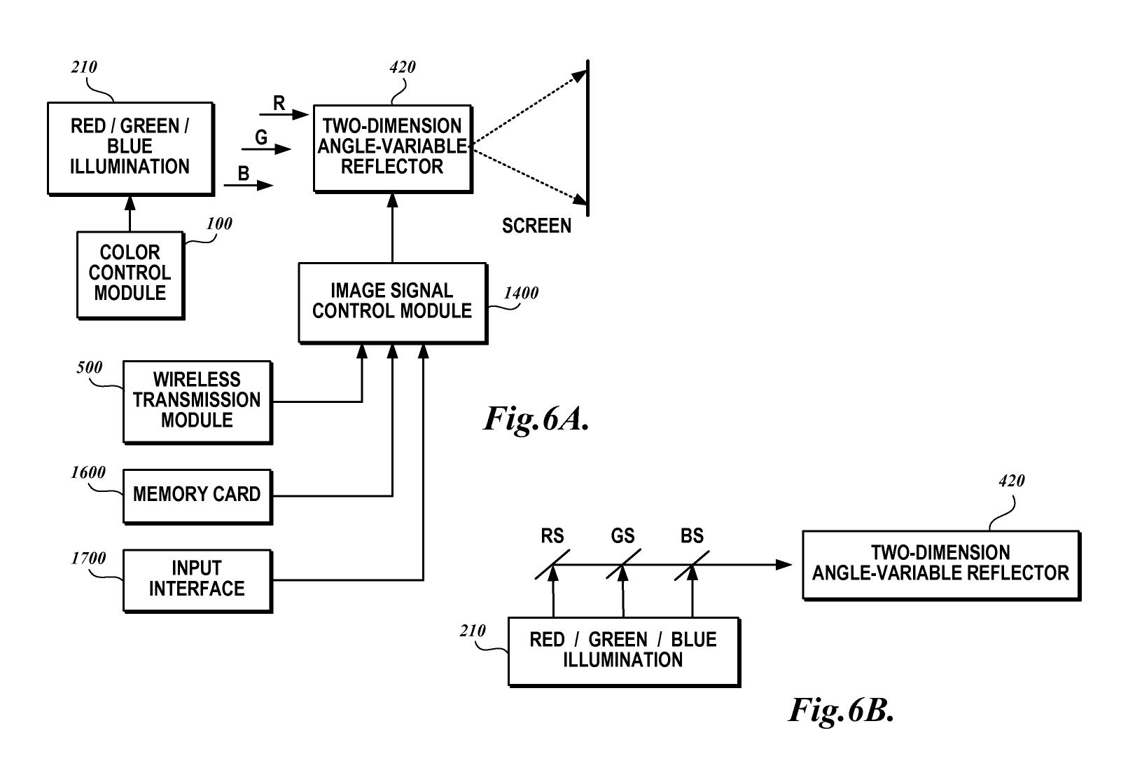

In one embodiment, referring to FIG. 5, light-emitting (illumination) sources 210R, 210G, and 210B are employed and positioned in correspondence with the X cube (or prism) 400A, respectively. The light-emitting sources 210R, 210G, and 210B are set at the three sides of the X cube 400A. In one embodiment, the light-emitting sources 210R, 210G, and 210B are organic EL (electroluminescence) elements, OLED, LED or laser. Organic EL elements are electric-field light-emitting thin films that are capable of emission of red, green, and blue light. The light-emitting sources are formed adjacent to the X cube (or prism) 400A, respectively. The light-emitting sources 210R, 210G, and 210B are positioned on the three sides of the X cube (or prism) 400A; therefore, the optical path between each of the light-emitting sources and the reflector is equal. Thus, the data or file stored in the memory of the device can be projected on a screen or wall. It allows the user to project the image, game, or file on an external screen. The OLED or EL element is small, flat-form, and lightweight; therefore, it allows a small projector to be integrated in the portable device. FIG. 6 shows that the light-emitting sources 210R, 210G, and 210B are reflected by a reflector, and thereby projected by the two-dimension reflector 420.

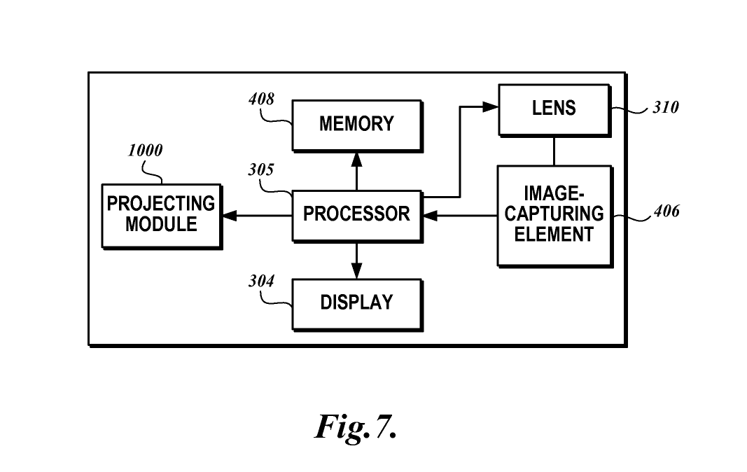

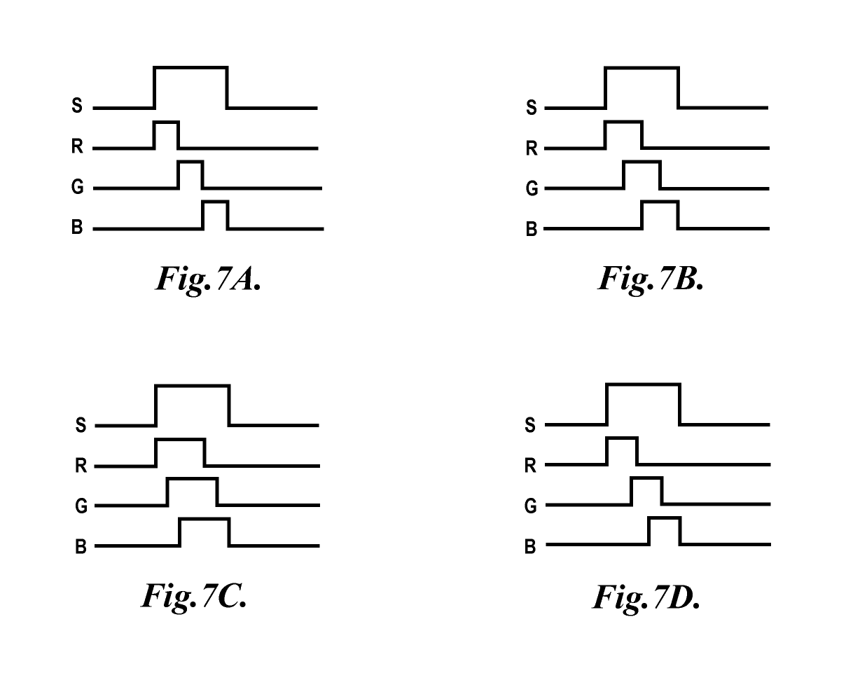

Further, referring to FIG. 7, the device includes a main body having a processor 305; a display 304 formed on the main body and coupled to the processor 305; an image capture element 406 formed within the main body and coupled to the processor 305; a memory 408 coupled to the processor 402; and a lens mechanism 310 formed on the main body, coupled to the processor 305 and corresponding to the image capture element 406. The projecting module 1000 is coupled to the processor of the portable device so as to project the captured image on a screen. The projecting module 1000 as disclosed above also can be used alone or in combination with other elements.

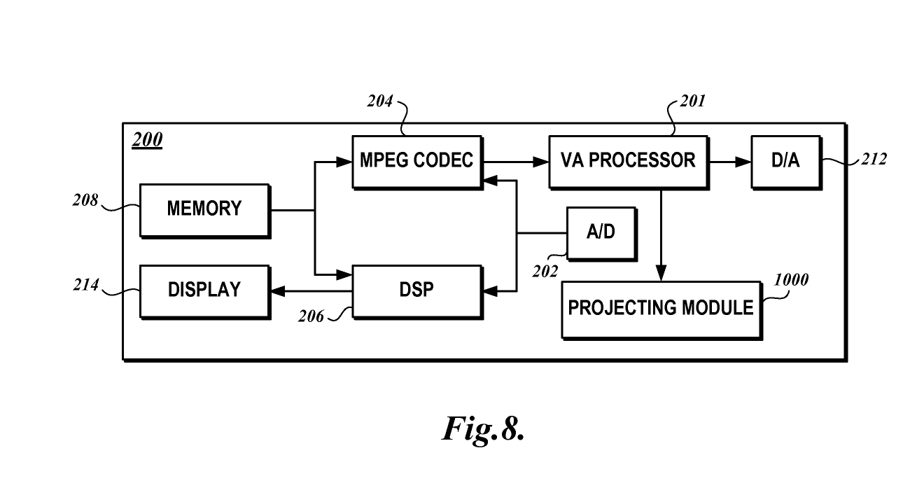

Referring to FIG. 8, the projecting module 1000 is employed for a media player such as an MP3 player or MP4 player. The player includes an analog/digital (A/D) converter 202 for converting analog audio signals into digital audio signals. The analog audio signals can come from an audio source coupled to the player 200. A digital signal processor (DSP) 206 or an audio and/or video driving module 204, for instance, an MP3 or MP4 codec, are coupled to the A/D converter 202 to receive the digital audio signals. In one embodiment, MP3 or MP4 codec 204 executes a firmware that includes an MPEG audio layer (e.g., MP3, MP2, or both) codec or video codec (e.g., MP4), and DSP 206 executes a firmware that includes a different type of audio codec (e.g., WMA, AAC, or both). In one embodiment, the firmware for DSP 206 also includes a video codec for encoding and decoding videos (e.g., MPEG-4 V1/V2/V3, DivX 3.11/4.0/5.0, Xvid, AVI/ASF, or any combination thereof). MP3 (or MP4) codec 204 and DSP 206 are coupled to a nonvolatile memory 208 that stores the compressed audio data. The user can select an audio file from nonvolatile memory 208. Codec 204 and DSP 206 are coupled to an audio processor 201, which processes the digital audio signals according to default settings or user instructions. Audio processor 201 is coupled to a digital/analog (D/A) converter 212, which converts the digital audio signals into analog audio signals for the user. A display 214 is coupled to the DSP 206. The projecting module 1000 as disclosed above can be used alone or in combination with other elements.

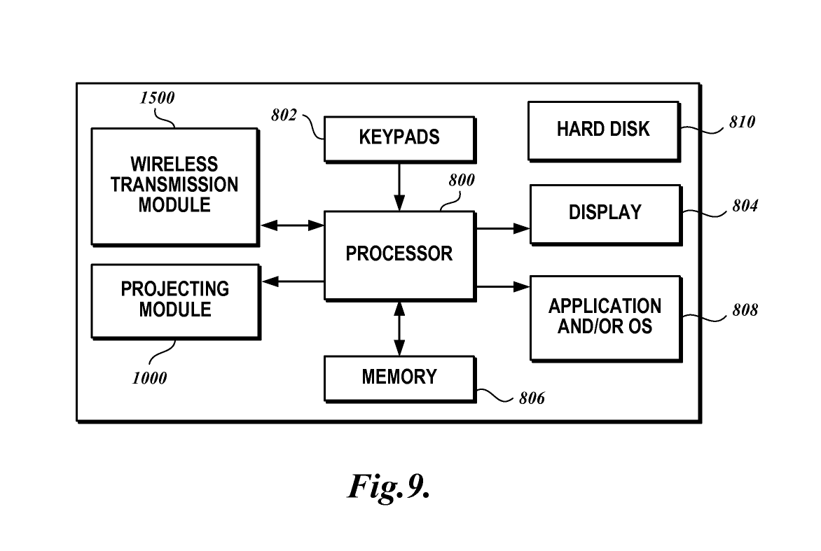

As shown in FIG. 9, the projecting module 1000 can be integrated into a portable computer system comprising: a processor 800 formed within the portable device; a keypad 802 formed on the portable device; a display 804 coupled to the processor; a memory 806 coupled to said processor 800. The device further includes an application and/or OS 808 and hard disk 810 coupled to the processor. It further includes the wireless transmission module (e.g., WLAN module) 1500 and the projecting module 1000. Similarly, the present disclosure describes embodiments that can be used in an electronic book reader.

An embodiment is now described with reference to FIG. 6A. The optical configuration of FIGS. 5-6 may be employed and integrated into FIG. 6A. The illumination unit 210 is coupled to the control IC 100. The control IC will transmit an image color control signal to the light sources 210R, 210G, 210B, respectively. The illumination unit 210 includes three color independent light sources, namely, red, green, and blue light sources, such as LED, OLED, or laser. The images will be enlarged and projected by the two-dimension reflector 420 onto a reflective screen, and thus displayed. It should be noted that the color combiner mentioned above is omitted to shrink the size of the device. The R, G, B light sources of the illumination unit 210 will independently emit light in sequence, based on the color instruction from the color control IC 100 which is coupled to the image signal control module 1400. In the example shown in FIG. 6A, wireless transmission module 500, memory card 1600, and input interface 1700 also are coupled to image signal control module 1400. The image signal control module 1400 determines the color of a specific pixel or location. Then, the color control IC 100 will instruct the R, G, B light sources of the illumination unit 210 to emit light independently with different power to obtain the determined color for a specific location. The three light beams are emitted at different times and arrive at the reflector 420 with a predetermined angle in sequence. Then, the reflector 420 will reflect the three beams to the predetermined location in the sequence. If the color is green, only the green light source will be emitted, accordingly. Based on the color mixture principle, any color can be achieved by a mixture of the three colors. During the persistence of vision phenomena, the eyes will detect the color image even if the light beams arrive at the location of the screen at different times. Therefore, the color is not combined by a combiner. The light from each of the light sources 210R, 210G, 210B is emitted in sequence, thereby constructing a demanded color which is determined by the control IC 100. A two-dimension angle-variable reflector 420 is coupled to the R/G/B light sources to reflect the non-combined light to a predetermined location on the screen. The two-dimension angle-variable reflector 420 may change the angle between the normal line of the screen and the reflected beam. Preferably, the two-dimension reflector 420 comprises a thin membrane which can reflect light along the X and Y axis to show the image pixel by pixel. It can be made by digital minor technology or micro-electromechanical systems. The light sources may include a laser, LED, or OLED to emit a light beam to the two-dimension reflector for horizontally moving the laser beam at a first sweep frequency along the X-axis, and vertically moving the laser beam up or down along the Y-axis. The control IC is operative for controlling a two-dimension reflector to ensure the pixel of the image can be reflected to a demanded location. A driver of the two-dimension reflector drives the angle of the two-dimension reflector. The driver horizontally sweeps X-direction to form a horizontal scan line from one point, then the drive adjusts the angle to move the scan line to the next vertical position, followed by sweeping again in the X-direction to form a second horizontal scan line along the X-direction. The formation of successive scan lines proceeds in the same manner. The whole image can be scanned by one two-dimension reflector and can be made by digital minor technology or micro-electromechanical systems. The projection image can be displayed by the two-dimension reflector.

Referring to FIG. 6B, splitters RS, BS, GS are aligned to the reflector 420, and the three R/G/B light sources aim at the splitters, respectively. It will let the incident light travel from one direction toward a certain direction and allow incident light to pass through from another direction under the scheme of a color sequence. The three different independent lights may be switched with a first frequency which is three times higher than the second frequency of the reflector (scanner). In this example, the three light sources will not be combined in a combiner. The X cube, X plate, or prism 400A of FIGS. 5 and 6 will be used to guide the light from three directions to the reflector, respectively, and will be combined by the eyes by the persistence of vision phenomena. The scheme may save power and energy because the three different independent light sources are not turned on all the time, and the three color light sources are not combined by a combiner, which can be omitted.

FIG. 7A shows the timing corresponding to a color sequence of the present disclosure, in one image signal frame denoted by S. At least three different color lights R, G, B are switched within the sequence and irradiated on the reflector. The switching rate of the three different color lights R, G, B is triple the rate of the image signal frame S. In the case where the signals of the color light sources R, G, B are not overlapped, each color light source is turned on, one by one, with ⅓ time of the image signal frame S. After a certain displaying time, each light source is switched on for only ⅓ of the total displaying time, thereby saving energy and life duration of the light sources. In order to balance between luminosity and power saving, the color control module may control the switching rate as shown in FIG. 7B, in which the first color light overlaps with the second color light with 50% of the total on-cycle of each light source. During the “on” cycle of the first color, the second color light source is also turned on within the later half of the on-cycle of the first color. Namely, turn-on time of the first color light source is overlapped with the second color light source by 50% of the total on-cycle of each light source to increase the luminosity but consuming more power. Similarly, the above scheme may be applied to the second color and third color light as well. Under the scheme, only two of the three colors are switched-on within a certain time. Namely, a second color light is not switched on until the later half of the on-cycle of the first color light source. When the first color light source is off (the half time of one image signal frame; half time of the second color light source on-cycle), the third color light source is on. Under the same scheme, the three different light sources are powered on with 50% overlapped time by color sequence to increase the photon number and luminance. At ¾ time of one image signal frame; half on-cycle time of the third color light source, the second color is off, and the first color may be turned on, depending on the demand; or the first color is off until next image signal frame S (the control will be easier). The switching rate of the light source is two times higher than the rate of the image signal frame S. FIG. 7C shows that the turn-on overlapped time between two different colors is longer than a half cycle of the on-cycle (but not totally overlapped) of each light source. In this case, three light sources may be turned on at the same time. FIG. 7D shows that the turn-on overlapped time between two different colors is shorter than a half cycle (50%) of each light source. In this case, only two light sources may be turned on at the same time. The turning on time of each light source is longer than FIG. 7A, but shorter than FIG. 7B. Thus, the color control module 100 may control the switching rate and turn-on time to control the overlap status to allow the overlapped time is equal, higher, less than half cycle (50%) of the turn-on time of each color light (illumination) source to the balance between luminosity and power saving. The present scheme may be used for four color light sources, the maximum switching rate of the different color light sources is four times the rate of the image signal frame S. The image signal is fed into the reflector to control its status.

A multiple rate projector comprises at least three different color light sources to illuminate a predetermined light, respectively; a color control module is coupled to the at least three different color light sources to switch the at least three different color light sources on, respectively, to allow turn-on times of two of the at least three different color light sources to not overlap, or the turn-on times of the two of the at least three different color light sources overlap by a half cycle, longer or shorter than half of the on cycle of each of the at least three different color light sources; and a two-dimension reflector reflects light from the at least three different color light sources to a location. A light-guiding device is provided to allow the at least three different color light sources located on three sides of the light-guiding device. The light-guiding device can include an X cube, an X plate, or a prism. The multiple rate projector may be integrated into a portable device such as a cellular phone, notebook computer, tablet, digital image capturing device, GPS device, or media player. In another aspect, the multiple rate projector comprises at least three different color light sources to illuminate a predetermined light, respectively. A color control module is coupled to the at least three different color light sources to switch the at least three different color light sources on; wherein a switching rate of the at least three different color light sources is a multiple of an image signal frame rate; and a two-dimension reflector reflects light from the at least three different color light sources to a location.

The present disclosure describes embodiments that may save power consumption and heat generated by the light sources, because the light sources are not always on.

Modification will suggest itself to those skilled in the art. Thus, the invention is intended to cover various modifications and similar arrangements included within the spirit and scope of the appended claims, the scope of which should be accorded the broadest interpretation so as to encompass all such modifications and similar structures.

While illustrative embodiments have been illustrated and described, it will be appreciated that various changes can be made therein without departing from the spirit and scope of the invention.

The embodiments of the invention in which an exclusive property or privilege is claimed are defined as follows:

1. A multiple rate projector comprises:
at least three different color light sources each configured to emit a different color of light, respectively;
a color control module coupled to said at least three different color light sources, wherein said color control module is configured to switch said at least three different color light sources, respectively, to allow turn-on times of two of said at least three different color light sources to overlap or to not overlap; and
a two-dimension reflector configured to reflect light emitted from said at least three different color light sources to a predetermined projection location.

2. The multiple rate projector of claim 1, further comprising a light-guiding device configured to allow said at least three different color light sources to be located on three sides of said light-guiding device.

3. The multiple rate projector of claim 2, wherein said light-guiding device is selected from the group consisting of: X cube, X plate, and prism.

4. The multiple rate projector of claim 1, wherein said at least three different color light sources comprise a laser.

5. The multiple rate projector of claim 1, wherein said at least three different color light sources comprise an LED.

6. The multiple rate projector of claim 1, wherein said at least three different color light sources comprise an OLED.

7. The multiple rate projector of claim 1, wherein said multiple rate projector is integrated into a portable device.

8. A multiple rate projector comprising:
at least three different color light sources each configured to emit a different color of light, respectively;
a color control module coupled to said at least three different color light sources, wherein said color control module is configured to switch said at least three different color light sources, wherein a switching rate of said at least three different color light sources is a multiple of an image signal frame rate; and
a two-dimension reflector configured to reflect light emitted from said at least three different color light sources to a predetermined projection location.

9. The multiple rate projector of claim 8, further comprising a light-guiding device configured to allow said at least three different color light sources to be located on three sides of light-guiding device.

10. The multiple rate projector of claim 9, wherein said light-guiding device is selected from the group consisting of: X cube, X plate, and prism.

11. The multiple rate projector of claim 8, wherein said at least three different color light sources comprise a laser.

12. The multiple rate projector of claim 8, wherein said at least three different color light sources comprise an LED.

13. The multiple rate projector of claim 8, wherein said at least three different color light sources comprise an OLED.

14. The multiple rate projector of claim 8, wherein said multiple rate projector is integrated into a portable device.

15. The multiple rate projector of claim 14, wherein said portable device is selected from the group consisting of: cellular phone, notebook computer, tablet, digital image capturing device, GPS device, and media player.

16. The multiple rate projector of claim 8, wherein said at least three different color light sources comprise a red light source, a green light source, and a blue light source.

17. The multiple rate projector of claim 7, wherein said portable device is selected from the group consisting of: cellular phone, notebook computer, tablet, digital image capturing device, GPS device, and media player.

18. The multiple rate projector of claim 1, wherein said at least three different color light sources comprise a red light source, a green light source, and a blue light source.

19. A method comprising:
by an illumination unit of a projector, emitting light of a color selected from at least three different colors, wherein said illumination unit comprises at least three different color light sources, and wherein said emitted light corresponds to an image signal having an image signal frame rate;
by a color control module coupled to said illumination unit, switching said color of said emitted light by turning said color light sources on or off at a frequency that is a multiple of said image signal frame rate; and
by a two-dimension reflector of said projector, reflecting said emitted light to facilitate projection of said emitted light.

20. The method of claim 19, wherein said projector is integrated into a portable device.
